(19) United States
(12) Patent Application Publication
(10) Pub. No.: US 2017/0154546 A1
(43) Pub. Date: Jun. 1, 2017

(54) LEXICAL DIALECT ANALYSIS SYSTEM

(71) Applicant: Jobu Productions, New York, NY (US)

(72) Inventors: Jerome Butler, New York, NY (US); Bensiin Borukhov, Everett, MA (US)

(21) Appl. No.: 15/118,831

(22) PCT Filed: Aug. 20, 2015
(86) PCT No.: PCT/US15/46155

§ 371 Date: Aug. 12, 2016

Related U.S. Application Data
(60) Provisional application No. 62/040,308, filed on Aug. 21, 2014.

(51) Int. Cl. G09B 19/06; G10L 15/187; G06F 17/30

(52) U.S. Cl. CPC G09B 19/06; G06F 17/30746; G06F 17/30684; G10L 15/187; G10L 15/005

(57) ABSTRACT

Techniques for using a lexical dialect analysis system to analyze words based on sound pattern constraints and non-sound specific constraints are described herein. A first set of sound pattern constraints specifying word positions of phonetic sounds is applied to a set of lexicon entries to produce a first subset of the set of lexicon entries. A second set of non-sound specific constraints specifying non-sound specific aspects of words is also applied to the set of lexicon entries to produce a second subset of the set of lexicon entries. The lexicon entries that satisfy both sets of constraints are returned.

### BACKGROUND

Learning a new language or improving an accent for an existing language may be a difficult process. A person trying to speak with an accent for a particular language with unfamiliar vowel and consonant sounds may resort to using similar sounds from their native language that, while they may sound correct to that non-native speaker, sound very different to a native speaker. If the person is not provided with familiar examples of equivalent sounds, that person may never know the difference and may always speak with an inaccurate accent.

### BRIEF DESCRIPTION OF THE DRAWINGS

Various embodiments in accordance with the present disclosure will be described with reference to the drawings, in which:

FIG. 1 illustrates an example environment where lexical queries may be processed in accordance with an embodiment;

FIG. 2 illustrates an example environment where entries in a lexicon database may be created in accordance with an embodiment;

FIG. 3 illustrates an example process for preparing and analyzing lexical queries in accordance with an embodiment;

FIG. 4 illustrates an example environment where a user interface may be used to generate lexical queries in accordance with an embodiment;

FIG. 5 illustrates an example environment where a user interface may be used to generate lexical queries in accordance with an embodiment;

FIG. 6 illustrates an example environment where a user interface may be used to generate lexical queries in accordance with an embodiment;

FIG. 7 illustrates an example environment where a user interface may be used to generate lexical queries in accordance with an embodiment;

FIG. 8 illustrates an example environment where the results of a lexical query may be marked up in accordance with an embodiment; and

FIG. 9 illustrates an environment in which various embodiments of the present disclosure can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described and suggested herein relate to systems and methods for identifying and analyzing sound patterns within a lexicon according to one or more dialects. A user interface may be used to generate a lexical query and the lexical query may be sent to a lexical dialect analysis system, which may process the lexical query using data stored in a lexicon database. The contents of the lexicon database may be categorized such that a user of the lexical dialect analysis system may search for sound patterns within the lexicon database, may analyze and mark up input files based on the lexicon database, may categorize input files according to the contents of the lexicon database, or may perform other analyses on input files. The input files may be, for example, text files, audio files, video files or other input files. The input files may first be pre-processed using, for example, automated speech recognition processes. The pre-processing may be performed by the lexical dialect analysis system and/or may be performed by one or more external or third party processes. Language and sub-language data within the lexicon database may provide a basis for further analysis of sounds based on, for example, accents, and/or dialects of a language. The further analysis of sounds based on the sub-language data may include, for example, an analysis based on how sounds produced by a native English speaker would differ from sounds produced by an English speaker with a German accent.

A lexical dialect analysis system may be used to improve dialect coaching (i.e., improve the process of training a native speaker of a first language to speak the first language with an accent like a native speaker of a second language or to speak the first language like a speaker of a sub-language or dialect of the first language) by allowing searches for familiar words in the first language that mimic the vowel and consonant sounds of a native speaker of the second language. For example, a speaker of American English who wishes to pronounce the word “fish” like a speaker of New Zealand English may use a lexical dialect analysis system to determine that the “i” in “fish” should be pronounced with the short “e” vowel sound in “step” rather than the short “i” vowel sound in “did.” Additionally, a lexical dialect analysis system may improve language learning (i.e., improve the process of training a native speaker of a first language to speak a second language with a proper accent) by allowing searches for familiar words in the first language and/or in the second language that mimic the vowel and consonant sounds of a native speaker of the second language. For example, a speaker of American English may find the proper pronunciation of the German “w” difficult, but may use a lexical dialect analysis system to determine that it should be pronounced like the “v” in “very.” Additionally, a lexical dialect analysis system may improve other language learning skills such as, for example, spelling. A non-native speaker of English may have difficulty determining the spelling of non-standard words (e.g., “neighbor”) or of determining the correct spelling of homophones (“wait” and “weight”). A lexical dialect analysis system may provide spelling guidance based on word pronunciation.

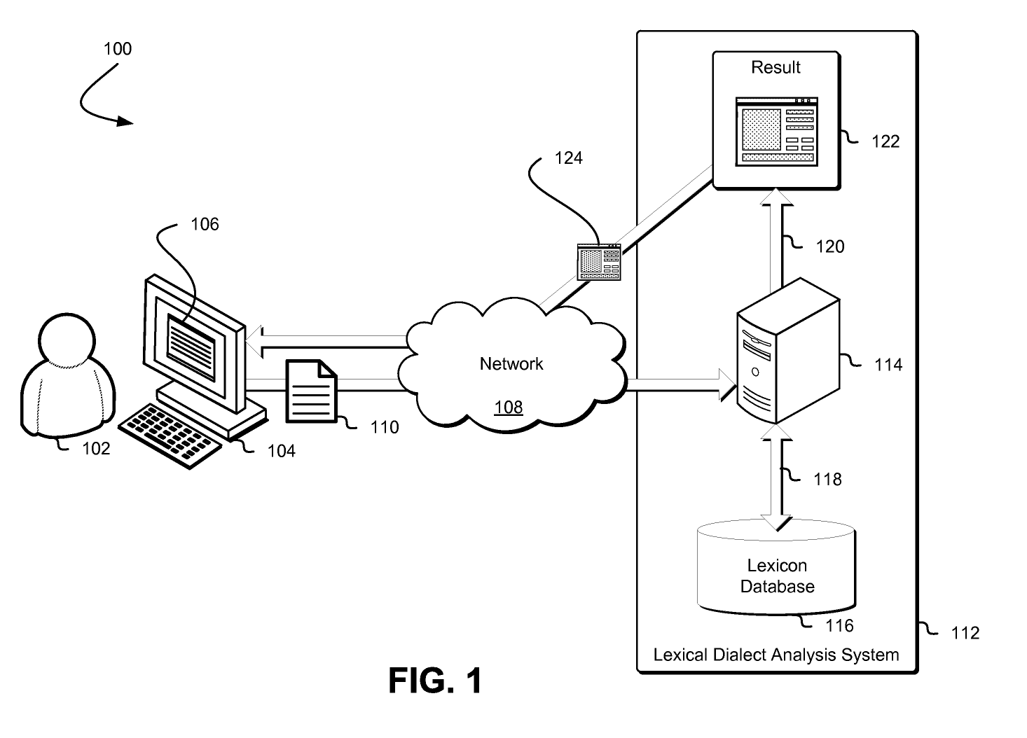

FIG. 1 illustrates an example environment 100 where one or more computer systems, as well as the associated code running thereon, may be used to process lexical queries in accordance with an embodiment. A user 102 may connect to a computer system 114 using a computer system client device 104 and may initiate processing of one or more lexical queries 110 using one or more applications running on the computer system 114 as part of a lexical dialect analysis system 112. In some embodiments, the user 102 may be a person, or may be a process running on one or more remote computer systems, or may be some other computer system entity, user, or process. The command or commands to connect to the computer system 114 may originate from an outside computer system and/or server, or may originate from an entity, user or process on a remote network location, or may originate from a user of the computer system client device 104, or may originate as a result of an automatic process or may originate as a result of a combination of these and/or other such origin entities. In some embodiments, the command or commands to initiate the connection may be sent to the computer system 114, without the intervention of the user 102 (i.e., automatically).

The user 102 may request connection to the computer system 114 via one or more connections and via one or more networks 108 and/or entities associated therewith, such as servers connected to the network, either directly or indirectly. The computer system client device 104 that may request access to the computer system 114 may include any device that is capable of connecting with a computer system via a network, including at least servers, laptops, mobile devices such as smartphones or tablets, other smart devices such as smart watches, smart televisions, set-top boxes, video game consoles and other such network enabled smart devices, distributed computing systems and components thereof, abstracted components such as guest computer systems or virtual machines and/or other types of computing devices and/or components. The network may include, for example, a local network, an internal network, a public network such as the Internet, a wide-area network, a wireless network, a mobile network, a satellite network, a distributed computing system with a plurality of network nodes, and/or the like. The network may also operate in accordance with various protocols, such as those listed below, Bluetooth, WiFi, cellular network protocols, satellite network protocols, and/or others.

The user 102 may connect to the computer system 114 using an application 106 operating on the computer system client device 104. The application 106 may be configured to generate one or more lexical queries 110 which may be sent over the network 108 to the computer system 114. The application 106 may be a web application configured to run within a web browser and to connect to the computer system using a protocol such as hypertext transfer protocol. The application 106 may be configured to receive input from the user 102 or from some other process and produce the one or more lexical queries 110 based at least in part on that input.

For example, the application 106 may include a user interface comprised of one or more user interface elements (e.g., drop-down boxes, text entry boxes, buttons, radio buttons, and other such user interface elements) and the user may interact with those user interface elements to generate the one or more lexical queries 110. In an embodiment, a lexical query is specified as a set of one or more variables representing the state of the user interface. In another embodiment, a lexical query is specified as a set of one or more regular expressions, the regular expressions generated by processing the state of the user interface. In another embodiment, a lexical query is specified as a set of one or more database commands, the database commands generated by processing the state of the user interface, the database commands based at least in part on the lexicon database 116 described herein. Each user interface element may correspond to a state variable of an application, or to a portion of a regular expression, or to a clause within a query to a database as described herein. As may be contemplated, the types of lexical queries described herein are illustrative examples and other such types of lexical queries may be considered as within the scope of the present disclosure.

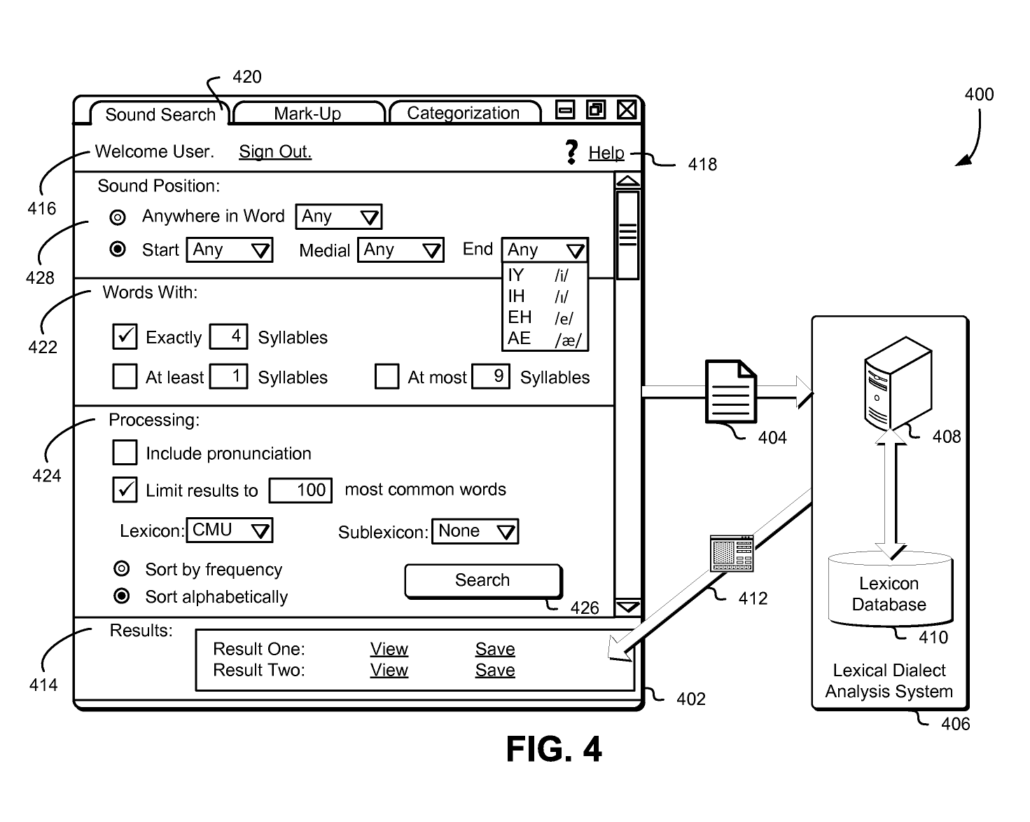

In an embodiment, a user selects options from user interface elements to generate constraints. Each selection from each user interface element corresponds to one or more variables associated with the state of the user interface. A user interface such as the user interface illustrated in FIG. 4 may have radio buttons, check boxes, dropdowns, text boxes, and other such user interface elements. In an illustrative example, a collection of user interface elements may be used to select sounds that appear in certain positions in a word. By selecting one option (e.g., a radio button) to return all words where a sound selected from a dropdown (e.g., the short “i” sound in the English word “sit,” which may be denoted as “IH” using Arpabet or “I” using IPA) appears anywhere in the word, a regular expression (also referred to as a “regex” or a “regexp”) may be generated.

As used herein, a “regular expression” is a series of characters or symbols that define a pattern. The pattern may then be used to locate matching entries in the lexicon database that match the pattern. The regular expression corresponding to “all words where the long ‘e’ vowel sound appears anywhere in the word” may be expressed as “.*IY.*” (using Arpabet) or as “.*i.*” (using IPA). In each of these regular expressions, the substring “.*” matches any number of characters (representing phonetic elements) including those with zero matches. So, for example, the Standard American English pronunciations of the words “eat,” “need,” and “eighty” all match the regular expression “.*IY.*” (using Arpabet) with the “IY” being in the first, medial, and last sound of the pronunciations respectively.

The regular expression may be generated from the user interface elements by, for example, mapping each option of each user interface element to at least a portion of a regular expression. A user interface element configured to allow a user to specify a sound pattern in the start of a word may be a dropdown list of possible sounds, which allows a single selection. As used herein, a “sound pattern” is a sequence of one or more sounds associated with the pronunciation of a word. For example, the word “infinity” has four syllables, (“IH0 N,” “F IH1,” “N AX0,” and “T IY0”) in Arpabet and (“In,” “‘fI,” “n [symbol] ,” and “ti”) in IPA with a stress on the second syllable (the “l” in Arpabet and the accent mark in IPA). The first syllable (“IH N” in Arpabet) has two sound patterns, the “IH” (as in “fish” or “sit”) and the “N” (as in “nice” or “any”). The first syllable is also a sound pattern, “IH N” (as in “inner” or “spin”). Sound patterns can be comprised of additional sets of syllables. For example, the first two syllables of infinity (“IH N” and “F IH”) also are a sound pattern (as in “infinite” or “Spinfisher®”). Sound patterns may be specified for lexical queries as single elements (e.g., “IH” or “N”) or as sequences of such elements (e.g., “IH N” or “IH N”; “F IH”).

Selecting a sound from the dropdown list may generate a regular expression with the selected sound (e.g., “IH” in Arpabet) in the first position in the regular expression, resulting in a regular expression of the form “̂IH.*”, which represents the first constraint. Selecting a second sound (e.g., “L” in Arpabet) from a second dropdown list corresponding to the end of a word may then alter the regular expression to be “̂IH.*L$”, which combines both constraints. The correspondence between the user interface elements and the regular expression elements may be hard coded (i.e., specified within the code), or may be contained in a lookup table in, for example, a database or other such table accessible by software associated with the lexical analysis system. The regular expressions may be generated dynamically (i.e., generated continuously as a user makes selections in the user interface), or may be generated as a result of a user action (e.g., clicking on a button such as a “search” button in the user interface).

In the first embodiment, another option (e.g., a second radio button) to allow a user to select sounds in certain positions within a word may also be presented to a user. For example, a user may select the second option and use a dropdown to select words where the Arpabet “AY” sound appears in different positions within the word. The regular expression corresponding to “all words where the long ‘i’ sound appears in the start of the word” may be expressed as “̂AY.*” (using Arpabet). The regular expression corresponding to “all words where the long ‘i’ sound appears in the end of the word may be expressed as “.*AY$” (using Arpabet). The regular expression corresponding to “all words where the long ‘i’ sound appears in the medial part of the word” may be expressed as “.+AY[012;]*[̂012;]+” (using Arpabet). The “.+” at the start of this regular expression indicates that one or more characters (which represent other phonetic elements) must precede the “AY” sound. The “[012;]*” immediately after the “AY” indicates that zero or more instances of spaces, the digits zero through two (which represent vowel stress), or semi-colons (which represent syllable boundaries) may occur immediately after the vowel. The final portion of this regular expression, “[̂012;]+”, indicates that following the potential spaces, numeric stress markers, or semi-colons, one or more occurrences of symbols which are not in that group (i.e. which must represent other phonetic elements) must occur. Placing the “AY[012;]*” between the “.+” and “[̂012;]+” ensures that an instance of “AY” which matches this expression is a medial sound occurring between other phonetic elements.

Additional user interface elements may be used to generate additional constraints on the query. For example, a user may request words with exactly three syllables or may request words with more than two syllables. A user may also select words from certain languages (e.g., the English language) or from certain sub-languages (e.g., American English or British English). Such additional constraints may be combined with the regular expression constraints (i.e., constraints formed based at least in part on the regular expressions described above) to produce a database query. The constraints may be combined using one or more Boolean operators to generate the database query. As described above, the lexical analysis system may generate the regular expressions, the constraints, and/or the database constraints (described below) from the state of the user interface using hard coded correspondences between user interface elements and constraint elements.

The lexical analysis system may also determine the Boolean operators from the state and/or groupings of the user interface elements. For example, a grouping of three dropdowns corresponding to sound patterns in the start, the middle, and the end of a word may be grouped together. Because any candidate lexical entry should have the first sound in the start of the word, the second sound in the middle of the word, and the third sound at the end of the word, these three constraints should be grouped with an “AND” operator so that a lexical entry must satisfy the first constraint from the first dropdown, the second constraint from the second dropdown, and the third constraint from the third dropdown to be a candidate lexical entry. Alternatively, the regular expression constraints for each portion of the word indicated in the dropdowns may be grouped into a single regular expression for the entire word that includes all of the constraints of the regular expressions for each portion of the word. Other user interface elements may generate constraints with an “OR” operator (e.g., a list where multiple selections are allowed) or a “NOT” operator (e.g., by selecting an option denoting “all sounds except the selected sound”). As may be contemplated, the example methods illustrating how constraints are generated and combined based on user interface elements are merely illustrating examples and other such methods of generating and/or combining constraints may be considered as within the scope of the present disclosure.

In an example, a user may select user interface options to return all words with an “IH” sound in the start of the word, with at least three syllables, and in the English language. The corresponding regular expression may be “̂IH.*” (using Arpabet). This regular expression may also be considered a constraint (referred to herein as a “regular expression constraint”). A database query constraint corresponding to this regular expression constraint may be “WHERE arpabet_pronunciation MATCHES REGEXP(‘̂IH.*’).” Similarly, non-sound specific constraints may be generated that are based on non-sound specific aspects of a word. An example of a non-sound specific aspect of a word is the number of syllables of the word (e.g., that there are four syllables in the word “infinity”). Constraints may be generated based on these non-sound specific aspects of the word and a data base query constraint such as, for example, (“WHERE num_syllables>2”) may be generated. Similarly, a language constraint based on the non-sound specific aspect of language such as, for example, (“WHERE language=‘English’”) may also be generated. Using Boolean operators, a query such as “SELECT*FROM lexical_database WHERE arpabet_pronunciation MATCHES REGEXP(‘̂IH.*’) AND num_syllables>2 AND language=‘English’” may be generated. As may be contemplated, the syntax for the regular expressions and/or the syntax for the database queries described herein are merely illustrative examples and other regular expression syntaxes and/or database query syntaxes may be considered as within the scope of the present disclosure.

In an embodiment, the database query is generated directly from user interface elements without generating a regular expression. In such an embodiment, each dropdown element of the user interface corresponds to a variable (e.g., the start of a word) and each entry in the dropdown element corresponds to a value (e.g., Arpabet “IH”). A database query constraint of the form “WHERE arpabet_start=‘IH’” may then be generated. Such direct generation of database queries may be performed using techniques such as those described above in connection with generating and/or combining regular expressions.

So, in the example illustrated, selecting an entry from the user interface element corresponding to the start of the word may generate the “WHERE arpabet_start=” portion of the query, and the item chosen may append the “‘IH’” to the query. As described above the mapping from the user interface elements and values may be hard coded in software or may be in a lookup table stored in a database accessible by the lexical analysis software. In such a mapping, the user interface element may correspond to a variable (e.g., “arpabet_start”) and the entries in the user interface element may correspond to values for that variable (e.g., “IH”). In an embodiment, a constraint can be directly sent to a lexicon database that is appropriate configured (i.e., that has entries for the “arpabet_start” variable. In another embodiment, a constraint can be processed by the database engine to determine matches by, for example, generating the corresponding regular expression, searching for Arpabet entries at the start of a word, or using some other search method.

In another embodiment, the lexicon database is stored as a flat file with each entry stored as a single line in the flat file. Such a database may have no formal database structure and/or no data relations such as may exist in, for example, an SQL database. User interface elements may then be used to produce regular expressions as described above and then the regular expression matching features available in any of a number of computer languages may be used to return matching entries from the lexicon database flat file (e.g., Perl, Python, TCL, Ruby, C++, etc.). The additional constraints including, but not limited to, syllable counts or language may then be applied to the matching entries to generate the results corresponding to the user interface query.

In an illustrative example, a user 102 may make selections from a user interface of an application 106 to generate a lexical query with a set of constraints such as, for example, to search for words of at least three syllables, with a certain vowel sound in the first syllable (for example, the short “i” sound in the English word “sit”), followed by a nasal consonant (i.e., “n,” “m,” or “ng”), and with a stress on the second syllable. The lexical query may be comprised of this set of constraints, or may be comprised of one or more regular expressions based at least in part on this set of constraints, or may be comprised of one or more queries to a database based at least in part on this set of constraints as described above. The lexical query may be based on typed input entered by the user, or on audio data spoken by the user, or on a text input file selected by the user, or from an audio input file selected by the user, or on a video input file selected by the user, or on some other type of data. The input files may be generated at the time of the query, or may be loaded from a local storage location such as, for example, an attached storage device, or may be loaded from a remote storage location such as, for example, a storage location accessible using a network such as the Internet, or may be loaded from some other location.

The set of constraints, the one or more regular expressions, and/or the one or more queries to a database may be generated at least in part on the user device 104, may be generated at least in part on the computer system 114, or may be generated using a combination of these and/or other computer systems. As described above, the queries may be generated from the user interface elements using regular expressions, constraints on the number of syllables (e.g., a number of syllables, a minimum number of syllables, or a maximum number of syllables), constraints on the language and/or sub-language, constraints on word frequency, or constraints on other such aspects of each entry in the lexicon database and may also be combined using one or more Boolean operators (e.g., “OR,” “AND,” and “NOT”).

The one or more regular expressions may be based on and/or may be compliant with one or more specifications including, but not limited to, a computer language specification (for example, Python) or a standard (for example, the Portable Operating System Interface (“POSIX”) standard). The one or more queries to a database may be based on a particular database service or may be based on a standard database query language such as the Structured Query Language (“SQL”). The one or more queries to a database may also be based on a document-based database service (e.g., MongoDB) that uses structured queries rather than a database query language and matches results to queries based on pattern matching, regular expressions, or some other matching method.

It should be noted that a variety of systems for describing phonetic sounds may be used herein. For example, the above mentioned phonetic sound for the short “i” sound in the English word “sit” may be described using an example word (“sit,” in this instance), or may be described using an Arpabet phonetic transcription code (“IH,” in this instance), or may be described using a phonetic alphabet such as the International Phonetic Alphabet (“IPA”) transcription (“I,” in this instance), or may be described using some other such phonetic system to represent the corresponding phonetic sound. As may be contemplated, while various aspects of the systems and methods described herein may be illustrated as providing input and/or output using one or more of these phonetic systems and/or phonetic alphabets, other such phonetic systems and/or phonetic alphabets may be considered as within the scope of the present disclosure.

In addition to the exact phonetic search described above, an approximate phonetic search using one or more heuristics to determine the best match for a set of sound pattern constraints may be performed. For example, a query to locate a “B” sound at the start of a word followed by an “EH” sound may be performed. For an approximate phonetic search, the lexical analysis system may perform a query with those sounds, in those locations, and in that order. This first query may return the word “best,” but some queries may not return any responses and/or may not return a significant number of responses. For an approximate phonetic search, the lexical analysis system may perform additional queries relaxing the sounds (e.g., search for a “P” sound followed by an “EH” sound as in “pest”), the locations (e.g., a “B” sound followed closely, but not immediately by an “EH” sound as in “breast”), or the order (e.g., an “EH” sound followed by “B” sound as in “ebb”). The lexical analysis system may continue performing broader and broader queries based on, for example, greater distance between the sounds within the word, more dissimilar sounds, or permutations of other constraints. Broader queries may be particularly useful in instances where the narrower queries do not return a significant number of results that satisfy the constraints of the exact phonetic search such as, for example, when a user specifies a minimum number of results to return to provide enough examples to illustrate a particular sound. Such broadening of queries may be specified and/or configured by a user to determine whether queries may be broadened, in what way they may be broadened, and how broad they may become based on, for example, a number of satisfied constraints that must be met. Broadening by, for example selecting different vowel and/or consonant sound patterns may be encoded into the lexical analysis service (e.g., that “b” and “p” are related sounds), thus reducing the number of satisfied constraints that must be met by the query by combining or relaxing constraints.

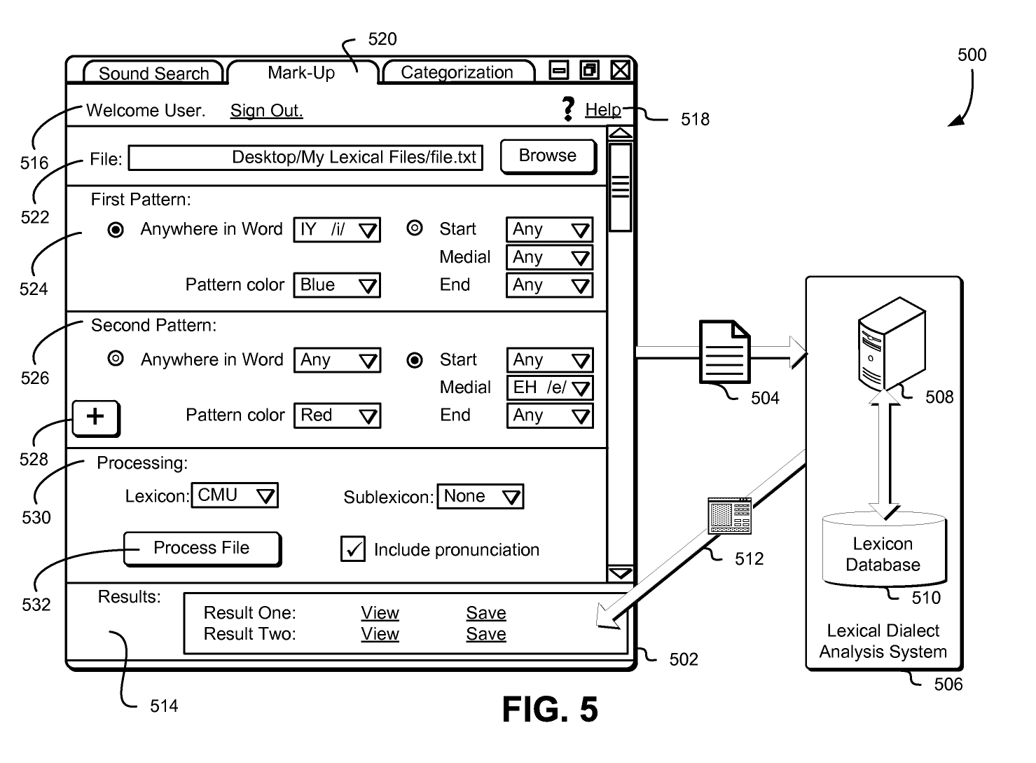

Once received by the computer system 114, the one or more lexical queries 110 may be sent 118 to a lexicon database 116. The computer system 114 may perform one or more processes on the one or more lexical queries 110 such as, for example, formatting the one or more lexical queries 110, adding information to the one or more lexical queries 110, analyzing the input files, and/or other processes. For example, a user may wish to select words from a source document that match a lexical query such as those described above (e.g., corresponding to one or more sound pattern constraints and/or one or more non-sound specific constraints). The computer system 114 may first perform an operation to extract the words from the document by, for example, removing punctuation, removing capitalization, and/or remove duplicates. The computer system 114 may then perform a series of options to query the lexicon database 116 to determine whether each of the words matches any of the constraints by, for example, looking up the lexicon entry corresponding to each word. The computer system 114 may then mark up those words that match one or more constraints and may, in some embodiments, reassemble the document (e.g., with punctuation, capitalization, and/or duplicates) with the words that match the one or more constraints so marked up. Marking up words is described in more detail in connection with FIG. 5. The computer system 114 may perform one or more markup operations to mark up those words that match one or more constraints by, for example, altering one or more font characteristics (also referred to as “font attributes”) of the words. Font attributes include font color, whether the word is in boldface or not, the font size, whether the word is italicized (i.e., is in italics or not), whether the word is underlined, and other such visual characteristics of a font.

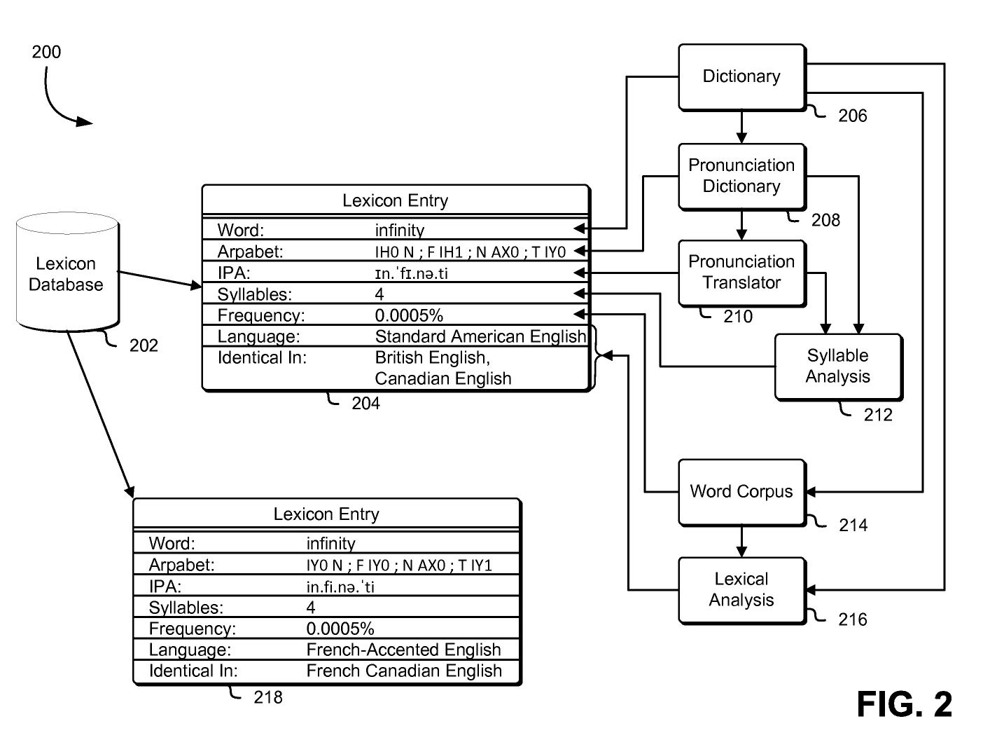

The lexicon database, described herein in connection with FIG. 2, may be configured to respond to such lexical queries 110 by providing a response back to the computer system 114 which may perform additional processes on the response, including preparing 120 the response as a result 122. The result 122 may then be sent 124 to the client device 104 via the network 108. In an embodiment, the result 122 is stored in a location (e.g., a database or other such data storage location) within the lexical dialect analysis system 112 and a reference to the result may be sent 124 to the client device 104. In such an embodiment, the reference to the result can be, for example, a uniform resource locator (“URL”). The result 122 may include one or more files (i.e., text files, audio files, or other such files), one or more dynamically and/or statically generated web pages, one or more references to the response, or combinations of these and/or other such result objects. The result 122 may also include one or more references to such result objects.

FIG. 2 illustrates an example environment 200 where an entry within a lexicon database may be created as described herein in connection with FIG. 1 and in accordance with an embodiment. The lexicon database 202 may contain a set of one or more lexicon entries such as the lexicon entry 204. The lexicon database 202 may store the set of one or more lexicon entries in one or more database tables such as the database tables associated with a relational database (an example of which is a “MySQL” database). The lexicon database 202 may also store the set of one or more lexicon entries in a flat file system, or in an indexed file system, or in a document database (an example of which is a “MongoDB” database), or using some other data storage mechanism. In addition to the lexicon entries, the lexicon database may store additional related information such as phonetic representation lookup tables, help files, results objects and/or other such related information.

In an embodiment, a lexicon entry includes a word, one or more phonetic pronunciations such as those described herein, the number of syllables of the word, the frequency count of the word (i.e., how common the word is in a representative corpus), which language the word may belong to, which sub-language (if any) the word may belong to, and other such information. The example lexicon entry 204 is for the English word “infinity.” The word may be stored in a lower case written form (“infinity,” in this example) that is stripped of all capitalization and punctuation. This normalized form of the word may be configured to facilitate easier searches for the word, so that, for example, a search for “infinity,” “Infinity,” or “INFINITY” (and/or other word forms) may yield the same search results, all based on a search for the normalized form. The capitalization and/or punctuation information may be retained so that the original input may be reproduced after processing. Retaining such capitalization and/or punctuation information may be used to reproduce the sentence and/or paragraph structure of a source document where multiple query words are processed. It should be noted that the examples illustrated herein are illustrated using the English language, but the systems and methods described herein may apply equally well to other languages.

A lexicon entry may also include one or more phonetic pronunciations of the word. In the example lexicon entry 204, a first pronunciation (“Arpabet”) and a second pronunciation (“IPA”) are shown. The first pronunciation, “IH0 N; F IH1; N AX0; T IY0,” is the Arpabet phonetic pronunciation for the word “infinity” as described herein. The second pronunciation “In. ‘fI.n [symbol] .ti,” is the IPA pronunciation for the word “infinity” as described herein. A lexicon entry may also include additional information. The example lexicon entry 204 also includes the number of syllables of the word (e.g., “4”), the frequency of the word (e.g., “0.0005 percent”) and the language that the word may belong to (e.g., “Standard American English”).

In the example illustrated in FIG. 2, one or more “Identical In” entries are included in a lexicon entry to indicate that the word is the same in, for example, “British English” and “Canadian English.” A lexicon entry may also include these other equivalent language entries as additional “Language” entries and/or as separate lexical entries. Examples of different languages may include, for example, “American English,” “British English,” or “English with a German Accent.” An example of a different lexicon entry for the word “infinity” is the lexicon entry 218, which shows the different pronunciations of the word “infinity” in “French-Accented English” and in “French Canadian English.” The lexicon entry 218 shows that the word “infinity” is pronounced in a French accent with the Arpabet “IY” sound instead of the Arpabet “IH” sound in the first and second syllables and with the accent on the fourth syllable rather than on the second syllable.

A lexicon entry may also include one or more references to other data and/or metadata associated with a word. For example, a lexicon entry may include a reference to an audio file, a video file, a computer rendering or some other file that may illustrate the proper pronunciation of the word as spoken using one or more dialects and/or sub-dialects. The file may also include links to the Arpabet and/or the IPA pronunciation of all or part of the word, further illustrating the proper pronunciation.

The example environment 200 illustrated in FIG. 2 also illustrates an example method for producing the lexicon entries in the lexicon database. In the example method, the word entry for a lexicon entry may come from a dictionary 206. The dictionary 206 is a dictionary of words (i.e., a list of words in one or more languages). The dictionary 206 entry may be used to locate the first pronunciation in a pronunciation dictionary 208 (an example of which is the Carnegie-Melon University Pronouncing Dictionary, also referred to herein as the “CMU Pronouncing Dictionary” or more simply as “CMU,” which stores pronunciation entries in an Arpabet format). In an embodiment, the pronunciation entry from the pronunciation dictionary 208 entry may be used by a pronunciation translator 210 to produce one or more other pronunciation entries such as the second pronunciation entry, illustrated herein in IPA format. A pronunciation translator may also be configured to produce one or more files demonstrating proper pronunciation such as, for example, an audio recording of the proper pronunciation.

The pronunciation dictionary 208 entry and the one or more pronunciations from the pronunciation translator 210 may be used by a syllable analysis 212 system to determine the number of syllables in a word. In the example illustrated in FIG. 2, the word “infinity” has a first pronunciation of “IH0 N; F IH1; N AX0; T IY0” (in Arpabet) and a second pronunciation of “In.‘fI.n [symbol] .ti” (in IPA). Both pronunciations indicate four syllables (“IH0 N,” “F IH1,” “N AX0,” and “T IY0”) in Arpabet and (“In,” “‘fI,” “n [symbol] ,” and “ti”) in IPA with a stress on the second syllable (the “1” in Arpabet and the accent mark in IPA). The dictionary 206 entry may also be used to determine other data parameters associated with the word. For example, the dictionary 206 entry may be used to look up the word in a word corpus 214 (an example of which is the Google™ N-grams Million Word English Corpus) to determine the word frequency and may also be used to perform a lexical analysis 216 of the word to determine what language and/or sub-language the word may belong to. Although not shown in FIG. 2, the lexicon entry 218 may be similarly produced using the dictionary 206, the pronunciation dictionary 208, the pronunciation translator 210, the syllable analysis 212, the word corpus 214, and the lexical analysis 216 as described above in connection with the lexicon entry 204.

In the example lexicon entry shown, the first language is Standard American English as the word “infinity” is an English word and the specific variant of English (also referred to as a “dialect” or a “sub-language”) is Standard American English. This language indicates that the pronunciation is as if the word were pronounced by an American speaker of English. This word may also be pronounced the same way by a speaker of “British English” or “Canadian English” as indicated by the “Identical In” entries as described above.

Another example of a sub-language would be if “infinity” was pronounced by a person with, for example, a strong French accent (as illustrated in lexicon entry 218 and as described above). A speaker with a strong French accent may pronounce “infinity” differently than a native English speaker (for example, replacing “long e” sounds for the “short i” sounds and with stronger stress on the final syllable). In this example, the second language may be “English with a Strong French Accent” and the pronunciations would be altered accordingly (e.g., “IY0 N,” “F IY0,” “N AX0,” “T IY1” in Arpabet and “in,” “fi,” “n [symbol] ,” “‘ti” in IPA). The “Identical In” field for this lexicon entry indicates that this pronunciation would be the same for a “French Canadian English” speaker.

In addition to creating new lexicon entries and/or new lexicons corresponding to a language, sub-language, or dialect by importing data from dictionaries as described above, new lexicon entries and/or new lexicons may also be created by applying one or more sound transformation rules to existing entries. For example, residents of a certain city or region may pronounce final r-colored vowels (e.g., “car” or “yard”) in Standard American English by dropping the r-coloring. Using this knowledge, a lexicon for the accent for that city or region may be generated by applying a set of transformation rules to an existing Standard American English to produce the new lexicon.

In an embodiment, a word can be used to form the basis for a lexical query. For example, a user may enter the word “infinity” and search for words that are similar to the word “infinity.” Words that are similar to the word “infinity” may include words that have four syllables, or may include words that start with the Arpabet “IH” sound, or may include words with an accent on the second syllable, or may include words that have multiple Arpabet “IH” sounds, or may include words that end with the Arpabet “IY” sound, or may include words that match a combination of these and/or other characteristics of the word “infinity.” In such an embodiment, the user may be provided with a user interface to enter one or more words which may result in an initial lexical query to determine the word characteristics as described herein. As a result of that initial lexical query, the user may then be provided with a user interface to select one or more word characteristics to match, generating a second lexical query. These user interface inputs may then be used to generate constraints for queries to a lexical database as described above.

For example, an initial lexical query for words similar to “infinity” may yield characteristics indicating, for example, that the word has four syllables, has a stress on the second syllable, has two “IH” sounds, starts with an “IH” sound, and has other characteristics. The user may then select words that start with an “IH” to return a result including, for example, “infinite,” “infinity,” “is,” and “it” (as well as other conforming words). The user may also select words that start with an “IH” sound, with more than one syllable to return a result including, for example, “infinite” and “infinity” (as well as other conforming words). The result words may then be used to form the basis for further lexical queries by, for example, selecting such words for further analysis. Similarly, characteristics may be selected that do not match the result words. For example, the word “infinite” has a stress on the first syllable while the word “infinity” does not. A user may select the word “infinity,” and may search for words that start with an “IH” sound but that have a stress on the first syllable. Such a search would return a result including “infinite,” but not including “infinity.” As may be contemplated, the methods of combining lexical queries described herein are illustrative examples and other methods of combining lexical queries may be considered as within the scope of the present disclosure.

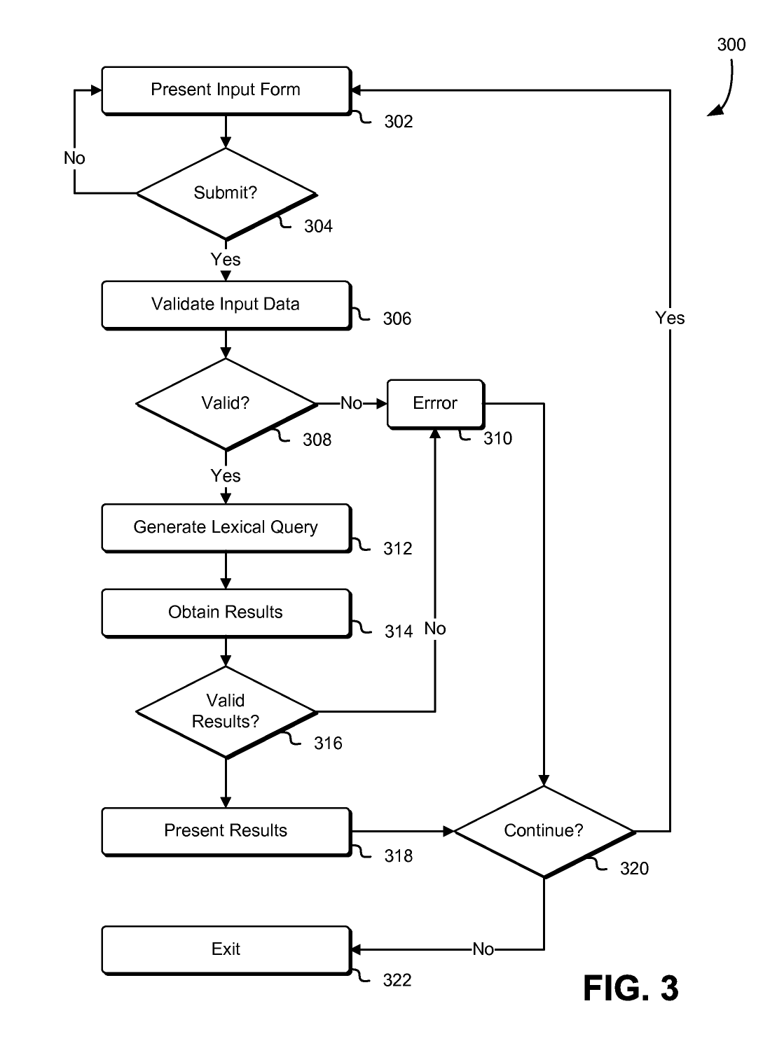

FIG. 3 illustrates an example process 300 for generating a lexical query from a user interface form and for receiving the results as described herein in connection with FIG. 1 and in accordance with at least one embodiment. A lexical dialect analysis system, such as the lexical dialect analysis system 112 described herein in connection with FIG. 1, may perform at least a portion of the process illustrated in FIG. 3. The lexical dialect analysis system may first present an input form 302 to a user such as the input forms described herein. The input form 302 may be presented as a web page, or as an application, or as some other input form type. After data entry has occurred, the lexical dialect analysis system may then determine whether the form has been submitted 304 by the user. The user may submit the form by, for example, pressing a button on the form. The lexical dialect analysis system may then validate the input data from the form 306 and, if valid 308, may generate a lexical query 312 based at least in part on that input data using, for example, regular expressions and/or other constraints such as those described above.

In an embodiment, the lexical dialect analysis system will generate an error 310 and display that error for the user if the input data from the form is not valid 308. As a result of the lexical query (the processing of which is described herein), the lexical dialect analysis system may obtain the results of the lexical query 314 and may first determine whether the results are valid 316 before presenting the results to the user 318 as described herein. In an embodiment, the lexical dialect analysis system will generate an error 310 and display that error for the user if the results are not valid 316. The lexical dialect analysis system may then determine whether the user wishes to continue 320 with the application. If it is the case that the user wishes to continue 320, the lexical dialect analysis system may present the input form 302 to the user. If it is not the case that the user wishes to continue 320, the lexical dialect analysis system may exit 322.

FIG. 4 illustrates an example environment 400 where a user interface 402 may be used to perform sound searches of data within a lexicon database as described herein in connection with FIG. 1 and in accordance with an embodiment. The user interface 402 may be used to generate a lexical query 404 as described above. The lexical query 404 may be sent to a lexical dialect analysis system 406 with a computer system 408 and a lexicon database 410 also as described above, at least in connection with FIG. 1. A result of the lexical query 412 may be returned and a reference to that result may be presented in a results section 414 of the user interface 402. The result may be presented in a results section 414 of the user interface 402 as a URL or as some other such link to one or more resources associated with the results (e.g., an output file or a detailed analysis of the results), which may be viewed and/or saved by the user. The result of the lexical query 412 may be presented by updating the results section 414 of the user interface 402 based at least in part on the result of the lexical query 412. The user interface 402 may be a local application user interface, may be a web page (e.g., may be updated using a uniform resource locator over a network), or may be a combination of these and/or other such user interface elements. The user interface 402 may also include a welcome area 416 which may include information including, but not limited to, a user identity, a “sign out” link, and/or other user account information. The user interface 402 may also include a “help” link 418, which may be configured to provide general and/or context-sensitive help related to the user interface 402.

The user interface 402 illustrates sound search 420 functionality which may allow a user to search for words within the lexicon database 410 that may match one or more sound patterns and that may also match one or more other word parameters. For example, a user may search for a sound that is in a sound position 428. The sound position 428 may be anywhere in the word, or in a position such as the start, medial, or end position. The sound position may be selected from a drop-down that may include sounds specified using, for example, the Arpabet phonetic representation, the IPA phonetic representation, or some other representation. The entries for vowels may include explicit stress markers, “r-coloring,” and/or other such vowel modifications. The sound position 428 section of the user interface 402 may then produce a regular expression based on the user interface state. For example, selecting a medial sound of “IY” may generate a regular expression specifying that the “IY” sound must occur after the word start and must also occur before the word end. The user interface 402 may also allow a user to specify 422 words that have a certain number of syllables or a certain range of syllables. Finally, the user interface 402 may allow a user to specify 424 how the results are processed and/or returned including whether or not to include pronunciation data with the returned words, how many words to return, which language and/or sub-language to use when searching for sounds and/or whether to sort the words by frequency (i.e., more common words first) or alphabetically (i.e., in alphabetic order). After the search parameters are specified, the user may initiate the search by, for example, clicking on a “search” button 426.

FIG. 5 illustrates an example environment 500 where a user interface 502 may be used to perform a file mark-up, using a lexicon database as described herein in connection with FIG. 1 and in accordance with an embodiment. The user interface 502 may be used to generate a lexical query 504 as described above. The lexical query 504 may be sent to a lexical dialect analysis system 506 with a computer system 508 and a lexicon database 510 also as described above, at least in connection with FIG. 1. A result of the lexical query 512 may be returned and a reference to that result may be presented in a results section 514 of the user interface 502. In an embodiment, the result may be presented in a results section 514 of the user interface 502 as a URL or as some other such link to one or more resources associated with the results (e.g., an output file or a detailed analysis of the results), which may be viewed and/or saved by the user. The result of the lexical query 512 may be presented by updating the results section 514 of the user interface 502 based at least in part on the result of the lexical query 512. As described above, the user interface 502 may be a local application user interface, may be a web page (e.g., may be updated using a uniform resource locator over a network), or may be a combination of these and/or other such user interface elements. The user interface 502 may also include a welcome area 516 which may include information including, but not limited to, a user identity, a “sign out” link, and/or other user account information. The user interface 502 may also include a “help” link 518, which may be configured to provide general and/or context-sensitive help related to the user interface 502.

The user interface 502 illustrates mark-up 520 functionality which may allow a user to analyze a file and to mark words within that file that match one or more specified sound patterns, by searching for those patterns within the lexicon database 510. A user may first browse for a file 522 and then may specify one or more pattern/color pairs that may be used to mark-up the file. In the example illustrated in FIG. 5, there is a first pattern 524 that specifies that words in the file that have the “IY” pattern anywhere in the word should be marked in blue and a second pattern 526 that specifies that words in the file that have the “EH” pattern anywhere in the medial position should be marked in red. The user interface 502 may allow a user to add additional patterns 528. The user interface 502 may also provide other pattern organization functionality including, but not limited to, functionality to remove patterns, functionality to save patterns, functionality to change the order of patterns, or other pattern organization functionality. As with the user interface 402 described herein in connection with FIG. 4, the user interface 502 may allow a user to specify 530 how the results are processed and/or returned including whether or not to include pronunciation data with the marked up file and/or which language and/or sub-language to use when searching for sounds. After the search parameters are specified, the user may initiate the mark-up process by, for example, clicking on a “process” button 532.

As a result of receiving a lexical query to mark-up a file, a lexical dialect analysis system may process the request by first splitting the file to identify each individual word. The individual words may have punctuation removed, may be converted to lower case, and may have other preprocessing operations performed. Each word may then be checked against each of the patterns to determine whether the word in question matches the pattern, based at least in part on the contents of the lexicon database 510. A word that matches a pattern may be marked with the color corresponding to that pattern. As the word may match more than one pattern, settings to determine the order of precedence of patterns may be provided by the system. In an embodiment, functionality to mark-up a word that matches multiple patterns with multiple colors may be provided by the lexical dialect analysis system.

In an embodiment, the lexical dialect analysis system is configured to mark-up only the letters in the word that correspond to the sound pattern. In such an embodiment, which letters in a word correspond to a sound pattern may be determined based at least in part on a spelling correspondence. For example, a search for the “IY” sound (as in “beat”) in a word may determine from the pronunciation that the sound is present, but a spelling correspondence may be configured to look for letter patterns that may correspond to that sound pattern (e.g., “ea,” “ee,” “i,” “y,” etc.) within the word. In an embodiment, the spelling correspondence can be ordered based on the frequency of the spelling in the particular language and/or dialect. This spelling correspondence may be generated by analyzing one or more pronunciation dictionaries and may be stored in the lexicon database 510. The fidelity of the spelling correspondence may be increased by performing one or more further analyses on the spelling correspondence including one or more further analyses based at least in part on frequency data, multiple pronunciation dictionaries, a word corpus, and/or other data.

The spelling correspondence may also be used to determine a letter sequence of one or more letters, which may be the closest and/or the most likely to correspond to a sound pattern. The closest (or most likely) letter sequence may be the letter sequence that has the least distance from the start of the letter sequence to the written form of the word (i.e., the lower-case, normalized version), the Arpabet form of the word, the IPA form of the word, or some other form of the word. For example, if a pattern is for word-initial liquid consonants (some “l” or “r” sounds), the first “l” in the English word “lullaby” is the closest (or most likely) to match the pattern. An algorithm for determining the correct letter sequence may start marking based on a tight tolerance for closeness which may be based at least in part on the length of the word, the number of syllables, or other such bases. The algorithm may then loosen the tolerance for those words where a match should be present, but is not found with the tighter tolerance. The number of times the algorithm may loosen the tolerance and/or the amount of tolerance to begin with and/or to loosen by may be changed for a different analysis.

The following pseudo-code listing illustrates the process of marking up words as described herein:

```
function mark_word (written, arpabet, patterns, recursion_depth,
                    tolerance, scaling, spellings)
{
    input: written - the written form of a word (potentially
                  partially marked)
            arpabet - the arpabet pronunciation of the word
            patterns - pairs of regular expressions identifying sound
                    patterns and word-processing mark-up
                    strings to mark the corresponding
                    written forms
            recursion_depth - integer value of the number of
                        recursive function calls to make
            tolerance - real number value of maximum distance
                    between correspondences in
                    pronunciation and writing
            scaling - real number value by which to scale up
                    tolerance for recursive calls
            spellings - a rank ordered list of likely spellings for
                    each sound
    output: written - the marked up written form of the word
    missed <- { }
    for each pattern in patterns:
        matches <- all Instances of pattern found in arpabet by
                  regular expression search
        for each match in matches:
            found <- false
            arpabet_distance <- average of the indices of the start
                              and end of match in arpabet
            for each spelling corresponding to the primary sound of
                match in spellings:
                written_matches <- all instances of spelling found in
                                  written by regexp search
                for each written_match in written_matches:
                    written_distance <- average of indices of the
                                      start and end of
                                      written_match in written
                    if evaluate_distance (written, arpabet,
                                      arpabet_position,
                                      written_position):
                        found <- true
                        written <- written with the spelling in
                                written_position marked based on
                                the mark-up in pattern
                        break out of the for each spelling loop
            if not found:
                add pattern to missed
    // If some matches are in missed and the number of calls have not
    // exceeded recursion depth, recursively call the function with a
    // reduced recursion_depth and tolerance scaled up by scaling
    if recursion_depth > 0 and missed != { }:
        return mark_word(written, arpabet, missed,
                                recursion_depth − 1,
                                tolerance * scaling, scaling,
                                spellings)
    return written
}
```

The pseudo-code listing illustrating the process of marking up words above uses the “evaluate_distance” function to determine how close a match a pattern is to a pattern based on regular expressions. The pseudo-code for the “evaluate_distance” function is illustrated in the following listing:

```
function evaluate_distance(written, arpabet, arpabet_position,
                      written_position)
{
    input: written - the written form of a word (potentially
                partially marked)
            arpabet - the arpabet pronunciation of the word
            arpabet_position - a number indicating the index of the
                            center of the regular expression match
                            in arpabet
            written_position - a number indicating the center of the
                            spelling corresponding to
                            arpabet in written
    output: true - if the arpabet_position is within a tolerance
                ratio of the written_position
          false - otherwise
    //Note: length(written) is calculated excluding mark-up
    // characters
    ratio <- length(written) / length(arpabet)
    if |arpabet_position - written_position * ratio| <
      ratio * tolerance:
      return true
    return false
}
```

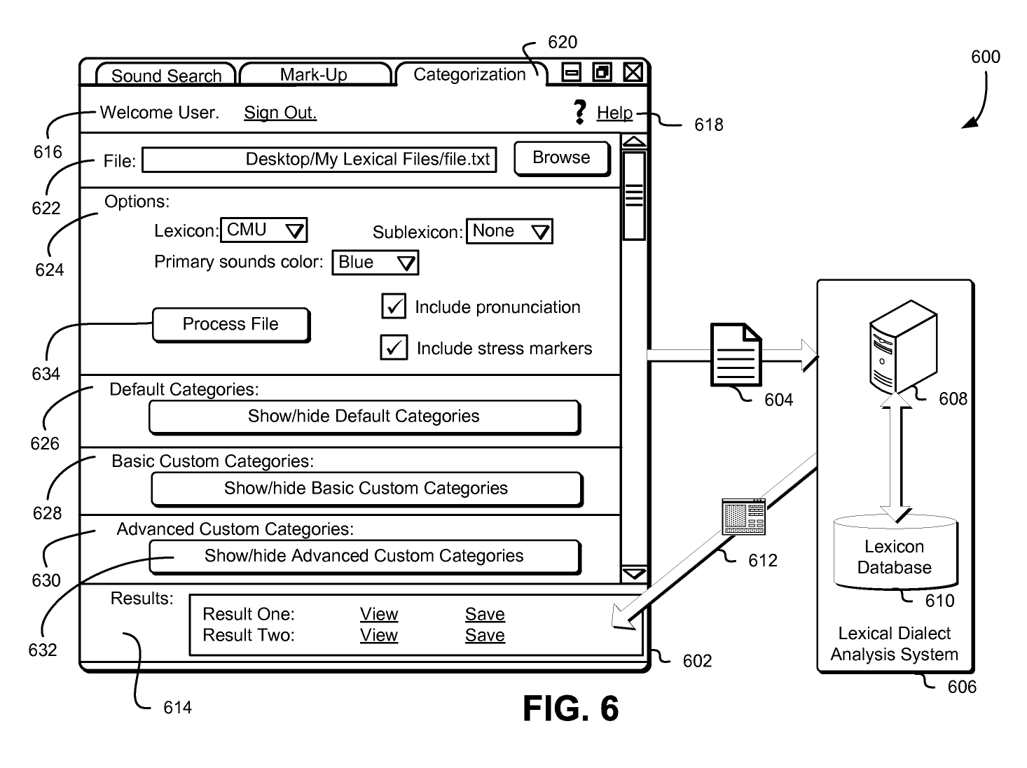

FIG. 6 illustrates an example environment 600 where a user interface 602 may be used to perform a basic lexical entry categorization of a file, using a lexicon database as described herein in connection with FIG. 1 and in accordance with an embodiment. The user interface 602 may be used to generate a lexical query 604 as described above. The lexical query 604 may be sent to a lexical dialect analysis system 606 with a computer system 608 and a lexicon database 610 also as described above, at least in connection with FIG. 1. A result of the lexical query 612 may be returned and a reference to that result may be presented in a results section 614 of the user interface 602. In an embodiment, the result may be presented in a results section 614 of the user interface 602 as a URL or as some other such link to one or more resources associated with the results (e.g., an output file or a detailed analysis of the results), which may be viewed and/or saved by the user. The result of the lexical query 612 may be presented by updating the results section 614 of the user interface 602 based at least in part on the result of the lexical query 612. As described above, the user interface 602 may be a local application user interface, may be a web page (e.g., may be updated using a uniform resource locator over a network), or may be a combination of these and/or other such user interface elements. The user interface 602 may also include a welcome area 616 which may include information including, but not limited to, a user identity, a “sign out” link, and/or other user account information. The user interface 602 may also include a “help” link 618, which may be configured to provide general and/or context-sensitive help related to the user interface 602.

The user interface 602 illustrates a basic categorization 620 functionality which may allow a user to load a file and to categorize words within that file that match one or more specified sound patterns, by searching for those patterns within the lexicon database 610. The search, which may be the same as the search described herein in connection with FIG. 1, may be performed by generating queries from a user interface that are based on constraints such as sound position, number of syllables, language, sub-language, word frequency, and/or other such constraints. A user may first browse for a file 622 and may select one or more other options 624 to specify how the results are processed and/or returned including whether or not to include pronunciation data with the categorized words from the file, whether or not to include stress markings with the pronunciation data, which color to mark-up the primary sounds with and/or which language and/or sub-language to use when searching for sounds.

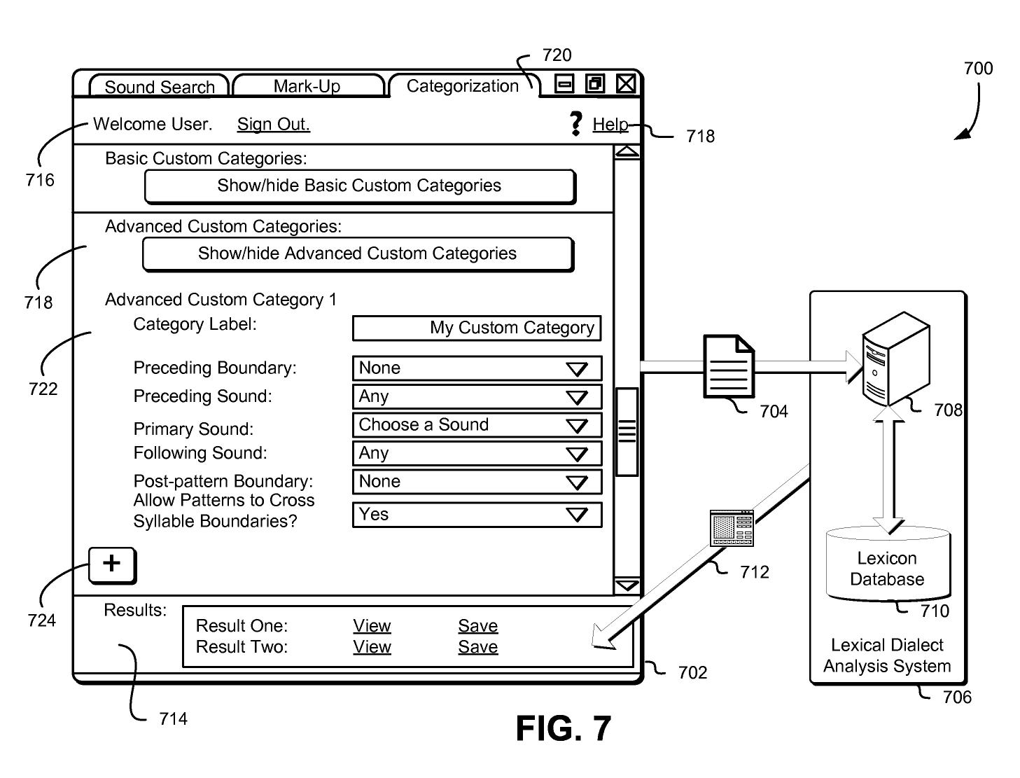

After the search parameters are specified, the user may initiate the categorization process by, for example, clicking on a “process file” button 634. The user interface 602 may also include one or more advanced options for categorization including, but not limited to, specifying which of the default categories 626 are selected (e.g., categories based on phonetic elements), specifying any basic custom categories 628 and/or specifying any advanced custom categories 630. The basic custom categories may be presented in a user interface like the user interface for the mark-up patterns illustrated in FIG. 5. The advanced custom categories may be presented in a user interface like the user interface illustrated in FIG. 7. The advanced custom categories may be accessed by clicking on the “Show/Hide Advanced Custom Categories” button 632.

As a result of receiving a lexical query to categorize a file, a lexical dialect analysis system may process the request by first splitting the file to identify each individual word. The lexical dialect analysis system may then process each word and add each word to a category specific list. Words that are not in the lexicon may be added to an “Unknown” category. In an embodiment, “Unknown” words are not processed. Other words may be categorized by determining which primary vowel category a word belongs to, based at least in part on stress markers in the phonetic representations of the word (described above). The default categories 626 may be based on a primary vowel in a word and/or on occurrence of r-colored schwa (the “er” in “her”). For any additional categories (beyond the default categories), the lexical dialect analysis system may look for patterns that match as described herein in connection with FIG. 5. When a word is added to a category, the word may be colored based on the category and may also have individual letters colored as described herein in connection with FIG. 5. Once all words have been categorized, the lexical dialect analysis system may output the categorized words to a file, or to a web page, or to some other such output so that the categorized words may be viewed by the user.

FIG. 7 illustrates an example environment 700 where a user interface 702 may be used to perform an advanced lexical entry categorization of a file, using a lexicon database as described herein in connection with FIG. 1 and in accordance with an embodiment. The user interface 702 may be used to generate a lexical query 704 as described above. The lexical query 704 may be sent to a lexical dialect analysis system 706 with a computer system 708 and a lexicon database 710 also as described above, at least in connection with FIG. 1. A result of the lexical query 712 may be returned and a reference to that result may be presented in a results section 714 of the user interface 702. In an embodiment, the result may be presented in a results section 714 of the user interface 702 as a URL or as some other such link to one or more resources associated with the results (e.g., an output file or a detailed analysis of the results), which may be viewed and/or saved by the user. The result of the lexical query 712 may be presented by updating the results section 714 of the user interface 702 based at least in part on the result of the lexical query 712. As described above, the user interface 702 may be a local application user interface, may be a web page (e.g., may be updated using a uniform resource locator over a network), or may be a combination of these and/or other such user interface elements. The user interface 702 may also include a welcome area 716 which may include information including, but not limited to, a user identity, a “sign out” link, and/or other user account information. The user interface 702 may also include a “help” link 718, which may be configured to provide general and/or context-sensitive help related to the user interface 702.

The user interface 702 illustrates an expanded view of the advanced categorization 720 functionality which may be accessed by clicking the “Show/Hide Advanced Custom Categories” button 632 described in connection with FIG. 6. The advanced custom categories 718 may include one or more categories for specifying word sounds to search for. For example, the advanced custom category 722 may include functionality to specify a custom category name, to specify a proceeding boundary for a sound, to specify a proceeding sound, to specify a primary sound, to specify a following sound, to specify a post-pattern boundary, and to specify whether the pattern may cross syllable boundaries. Specifications for syllable boundaries and/or whether patterns may cross syllable boundaries may introduce additional lexical query constraints and/or regular expressions into the lexical query 704. The user interface 702 may allow a user to add additional categories 724. The user interface 702 may also provide other category organization functionality including, but not limited to, functionality to remove categories, functionality to save categories, functionality to change the order of categories, or other category organization functionality. The advanced categorization interface 720 illustrated in FIG. 7 may be used in other sections of the user interfaces illustrated herein, including, for example, as an advanced view of the mark-up functionality described herein in connection with FIGS. 5 and 6.

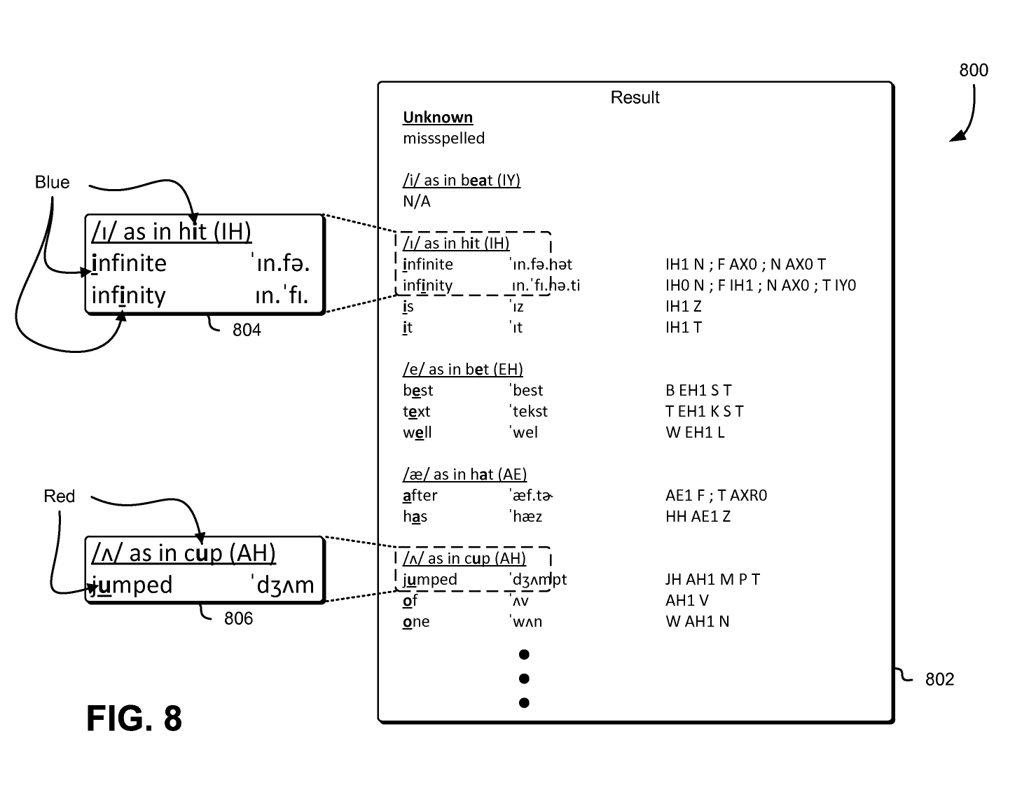

FIG. 8 illustrates an example environment where the result of a lexical query may be presented with mark up as described herein at least in connection with FIGS. 5-7 and in accordance with an embodiment. A result 802 may include an analysis of sound patterns of words from, for example, a text file, a transcript of an audio file, an audio file, a database of words from a source, or some other source. In the example illustrated in FIG. 8, a user may have selected two sound patterns to search for and may also have selected two mark-up methodologies for those sound patterns. For example, the user may have requested a search for primary stressed instances of the Arpabet sound pattern “IH” (IPA “I”) and may have indicated that the spelling corresponding to the sound pattern should be marked in blue. The result for that sound pattern 804 may have first “i” in the word “infinite” underlined, bolded, and colored blue and may have the second “i” in the word “infinity” underlined, bolded, and colored blue. The first “i” may be marked up for “infinite” due to the stress being on that first syllable, thus indicating the first “i” as the characteristic vowel. The second “i” may be marked up for “infinity” due to the stress being on the second syllable. Other sound patterns may be marked up with other colors. In another example, the user may have requested a search for the Arpabet sound pattern “AH” (IPA “Λ”) and may have indicated that sound pattern should be marked in red. The result for that sound pattern 806 may have the “u” in the word “jumped” underlined, bolded, and colored red. As may be contemplated, the mark-up methodologies described herein are illustrative examples and other methods of mark-up may be considered as within the scope of the present disclosure.

The result 802 illustrated in FIG. 8 also includes phonetic output from the lexical analysis database in both IPA and Arpabet formats. The result illustrated shows the marked up analysis of sound patterns of an input file (e.g., a text file, an audio file, a video file, or some other such file), but such phonetic output may be presented as part of the results of any of the queries illustrated herein. For example, the results of a sound search such as the sound search described in connection with FIG. 4 may include phonetic output for the lexical analysis entries that satisfy the constraints of the sound search. Such phonetic output may also be presented in connection with, for example, a phonetic transcription of an input file in an unfamiliar language and/or in an unfamiliar dialect. In such an example, a user that is learning to pronounce unfamiliar words and phrases may obtain a phonetic transcription of the unfamiliar words and phrases based on the proper language dialect and may then use that phonetic transcription to return words and phrases with corresponding sounds in a more familiar dialect and/or language. As an example, a native English speaker attempting to learn the proper pronunciation of the German “w” sound may be able to learn to correctly pronounce that sound upon determining, using a phonetic transcription, that it is pronounced like the “v” in the English word “over.”

A user may be able to utilize the lexicon database and/or lexical queries to obtain other information related to other tasks in language learning, analysis, dialect training, pronunciation training, and/or other such tasks. Such other tasks may be performed using existing user interface functionality and/or may be accomplished using new user interface functionality. For example, a user may be able to use the lexicon database and/or lexical queries as a spelling trainer when learning a new language. Various languages may contain unique spelling rules that have a direct relationship to their word pronunciation. A user attempting to learn a second language may use a lexical dialect analysis system to search for words matching a particular sound and may view those words in all of their various existing spellings.

For example, second language learners of English may face significant pronunciation challenges because modern day English pronunciations differ from spellings established centuries ago and because extensive borrowing from a range of other language groups has resulted in a wide variety of spelling rules and patterns in English. Learners of the English language could use a lexical dialect analysis system to aid in the understanding of these varied rules. For example, a user may use sound searching functionality of a lexical dialect analysis system to determine that “prison,” “exam,” “translation,” and “seized” all contain an Arpabet “Z” sound in the medial position while “pristine,” “exhale,” “placed,” and “useful” all contain an Arpabet “S” sound in the medial position. A user that may view words in this manner (with common sounds, but different spellings) could greatly aid in determining the organizational relationship between archaic and foreign spelling rules contained within English language pronunciation.

Similarly, native language speakers may also be able to use the lexicon database and/or lexical queries as a spelling trainer to learn and understand spelling rules of their native language such as, for example, in relation to correct spelling while writing words in script form. A lexical dialect analysis system may be used to reinforce and aid in understanding how to properly spell words that a native speaker already is clear on how pronounce. For example, a native English speaker may do a lexical query for an Arpabet “SH” sound (as in the “sh” in the word “shoe”), followed by an Arpabet “AX” (an unstressed shwa sound as in the “e” in the word “the”), followed by an Arpabet “N” (as in the “n” in the word “any”) occurring in the final syllable. The result of such a query may return words such as “depression,” “position,” “cushion,” “complexion,” “magician,” “ocean,” and “Martian” illustrating the variance in English language spelling for the Arpabet “SH” sound. Such an illustration may allow the user to improve spelling through visual comparison and may also allow a user to search for, and locate, related words.

Additional processing may then be performed on the result to, for example, reform sentences and/or paragraphs of the original document with marked up words and/or phonetic translations added so that a marked up document that corresponds to the original document may be produced. In an embodiment where the input comes from an audio source, the result may include the results of any speech-to-text processing of the input (i.e., a transcript) in addition to the marked up and formatted versions of that speech-to-text transcript.

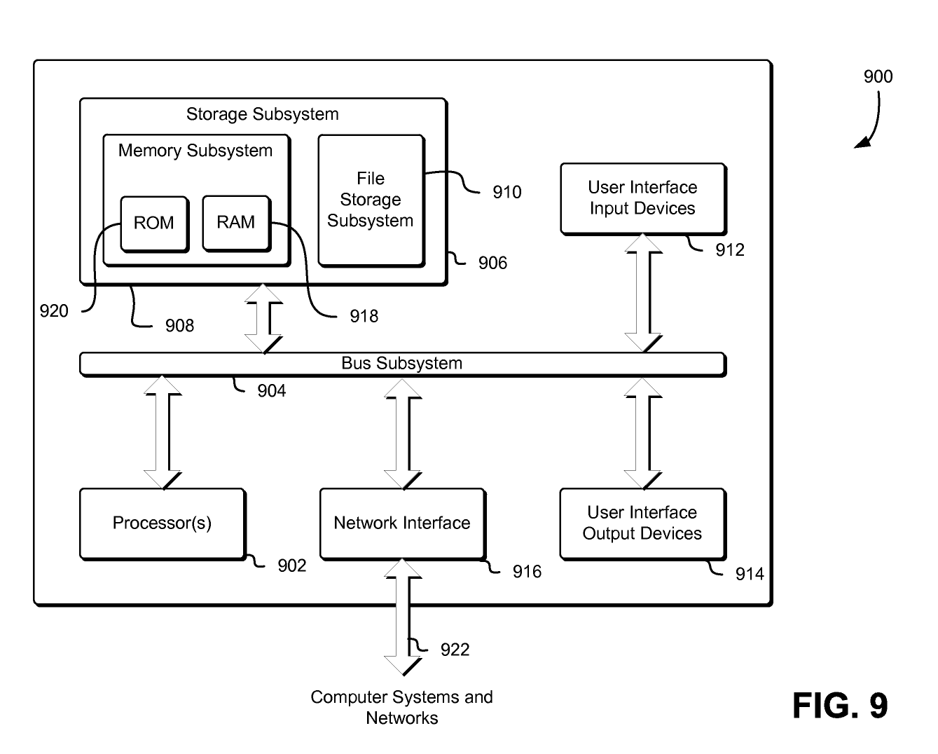

FIG. 9 is a simplified block diagram of a computer system 900 that may be used to practice an embodiment of the present invention. In various embodiments, the computer system 900 may be used to implement any of the systems illustrated and described above. For example, the computer system 900 may be used to implement processes for performing lexical queries according to the present disclosure. As shown in FIG. 9, the computer system 900 may include one or more processors 902 that may be configured to communicate with and are operatively coupled to a number of peripheral subsystems via a bus subsystem 904. These peripheral subsystems may include a storage subsystem 906, comprising a memory subsystem 908 and a file storage subsystem 910, one or more user interface input devices 912, user interface output devices 914, and a network interface subsystem 916.

The bus subsystem 904 may provide a mechanism for enabling the various components and subsystems of computer system 900 to communicate with each other as intended. Although the bus subsystem 904 is shown schematically as a single bus, alternative embodiments of the bus subsystem may utilize multiple busses.

The network interface subsystem 916 may provide an interface 922 to other computer systems and networks. The network interface subsystem 916 may serve as an interface for receiving data from and transmitting data to other systems from the computer system 900. For example, the network interface subsystem 916 may enable a user computer system device to connect to the computer system 900 via the Internet and/or other network, such as a mobile network, and facilitate communications using the network(s) and to generate and/or process lexical queries.

The user interface input devices 912 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. Further, in some embodiments, input devices may include devices usable to obtain information from other devices, such as the results of lexical queries, as described above. Input devices may include, for instance, magnetic or other card readers, one or more USB interfaces, near field communications (NFC) devices/interfaces and other devices/interfaces usable to obtain data (e.g., lexical queries) from other devices. In general, use of the term “input device” is intended to include all possible types of devices and mechanisms for inputting information to the computer system 900.

The user interface output devices 914 may include a display subsystem, a printer, or non-visual displays, such as audio and/or tactile output devices, etc. Generally, the output devices 914 may invoke one or more of any of the five senses of a user. For example, the display subsystem may be a cathode ray tube (CRT), a flat-panel device, such as a liquid crystal display (LCD), light emitting diode (LED) display, or a projection or other display device. In general, use of the term “output device” is intended to include all possible types of devices and mechanisms for outputting information from the computer system 900. The output device(s) 914 may be used, for example, to generate and/or present user interfaces to facilitate user interaction with applications performing processes described herein and variations therein, when such interaction may be appropriate. While a computer system 900 with user interface output devices is used for the purpose of illustration, it should be noted that the computer system 900 may operate without an output device, such as when the computer system 900 is operated in a server rack and, during typical operation, an output device is not needed.

The storage subsystem 906 may provide a computer-readable storage medium for storing the basic programming and data constructs that provide the functionality of the present invention. Software (programs, code modules, instructions) that, when executed by one or more processors 902, may provide the functionality of the present invention, may be stored in storage subsystem 906. The storage subsystem 906 may also provide a repository for storing data used in accordance with the present invention. The storage subsystem 906 may comprise memory subsystem 908 and file/disk storage subsystem 910. The storage subsystem may include database storage for the lexicon database, file storage for results files, and/or other storage functionality.

The memory subsystem 908 may include a number of memory devices including, for example, random access memory (RAM) 918 for storage of instructions and data during program execution and read-only memory (ROM) 920 in which fixed instructions may be stored. The file storage subsystem 910 may provide a non-transitory persistent (non-volatile) storage for program and data files, and may include a hard disk drive, a floppy disk drive along with associated removable media, a compact disk read-only memory (CD-ROM) drive, a digital versatile disk (DVD), an optical drive, removable media cartridges, and other like storage media.

The computer system 900 may be of various types including a personal computer, a portable computer, a workstation, a network computer, a mainframe, a kiosk, a server, or any other data processing system. Due to the ever-changing nature of computers and networks, the description of computer system 900 depicted in FIG. 9 is intended only as a specific example for purposes of illustrating the preferred embodiment of the computer system. Many other configurations having more or fewer components than the system depicted in FIG. 9 are possible.

The various embodiments further can be implemented in a wide variety of operating environments, which in some cases can include one or more user computers, computing devices or processing devices which can be used to operate any of a number of applications. A computing device may be configured to implement one or more services such as the services described herein (e.g., a lexical analysis service) and each service may be configured to perform one or more operations associated with the services. User or client devices may include any of a number of general purpose personal computers, such as desktop, laptop or tablet computers running a standard operating system, as well as cellular, wireless and handheld devices running mobile software and capable of supporting a number of networking and messaging protocols. Such a system may also include a number of workstations running any of a variety of commercially-available operating systems and other known applications for purposes such as development and database management. These devices may also include other electronic devices, such as dummy terminals, thin-clients, gaming systems and other devices capable of communicating via a network. These devices may also include virtual devices such as virtual machines, hypervisors and other virtual devices capable of communicating via a network.

Various embodiments of the present disclosure may utilize at least one network that would be familiar to those skilled in the art for supporting communications using any of a variety of commercially-available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, a satellite network, and any combination thereof.

In embodiments utilizing a web server, the web server may run any of a variety of server or mid-tier applications, including Hypertext Transfer Protocol (“HTTP”) servers, FTP servers, Common Gateway Interface (“CGI”) servers, data servers, Java servers, Apache servers, and business application servers. The server(s) may also be capable of executing programs or scripts in response to requests from user devices, such as by executing one or more web applications that may be implemented as one or more scripts or programs written in any programming language, such as Java®, C, C# or C++, or any scripting language, such as Ruby, PHP, Perl, Python or TCL, as well as combinations thereof. The server(s) may also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. Database servers may include table-based servers, document-based servers, unstructured servers, relational servers, non-relational servers or combinations of these and/or other database servers.

The environment may include a variety of data stores and other memory and storage media as discussed above. These may reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU” or “processor”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices may also include a computer-readable storage media reader, a communications device (e.g., a modem, a network card (wireless or wired), an infrared communication device, etc.), and working memory as described above. The computer-readable storage media reader may be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer-readable media for containing code, or portions of code, can include any appropriate media known or used in the art, including storage media and communication media, such as, but not limited to, volatile and non-volatile, removable and non-removable media implemented in any method or technology for storage and/or transmission of information such as computer-readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for identifying a set of lexicon entries within a lexicon database, comprising:
under the control of one or more computer systems configured with executable instructions,
receiving a set of sound patterns, each sound pattern of the set of sound patterns specifying a corresponding phonetic sound and a corresponding sound position, the corresponding phonetic sound specified using a phonetic alphabet, the sound position at least specifying one or more positions within a word;
generating a first set of constraints, each constraint in the first set of constraints generated from a corresponding sound pattern of the set of sound patterns by at least:
determining a regular expression based at least in part on the sound pattern; and
generating the corresponding constraint based at least in part on the regular expression;
receiving a second set of constraints, each constraint of the second set of constraints specifying one or more non-sound specific aspects of a word;
generating a third set of constraints by selecting a subset of the first set of constraints and a subset of the second set of constraints;
submitting a query to the lexicon database, the query generated based at least in part on one or more constraints from the third set of constraints;
receiving a response to the query from the lexicon database that comprises a set of lexicon entries that satisfy the third set of constraints, each lexicon entry of the set of lexicon entries that satisfy the third set of constraints satisfying a corresponding subset of constraints from the third set of constraints;
processing the set of lexicon entries that satisfy the third set of constraints by performing one or more operations on the set of lexicon entries that satisfy the third set of constraints; and
providing the set of lexicon entries that satisfy the third set of constraints by updating a user interface in accordance with a subset of the set of lexicon entries that satisfy the third set of constraints.

2. The computer-implemented method of claim 1, wherein the one or more non-sound specific aspects of the word include at least one of: a number of syllables of the word, a minimum number of syllables of the word, a maximum number of syllables of the word, a language of the word, a dialect of the word, or a frequency of the word.

3. The computer-implemented method of claim 1, wherein the lexicon database contains one or more lexicon entries, each lexicon entry at least specifying:
a word;
a language associated with the word; and
a set of pronunciations, each pronunciation of the set of pronunciations specified in a corresponding phonetic alphabet, each pronunciation based at least in part on the language associated with the word.

4. The computer-implemented method of claim 3, wherein:
the word is selected from a dictionary of words in the language;
the language is determined based at least in part on a lexical analysis of the word;
each pronunciation of the set of pronunciations is determined based at least in part on a pronunciation dictionary corresponding to the dictionary of words; and
the lexicon entry further specifies:
a word frequency determined based at least in part on a word corpus; and
a number of syllables for the word, the number of syllables determined based at least in part on the pronunciation dictionary.

5. The computer-implemented method of claim 1, wherein the one or more operations include at least one of: marking up the set of lexicon entries that satisfy the third set of constraints by altering one or more font attributes of the set of lexicon entries that satisfy the third set of constraints, sorting the set of lexicon entries that satisfy the third set of constraints based at least in part on an alphabetic order, sorting the set of lexicon entries that satisfy the third set of constraints based at least in part on a word frequency, sorting the set of lexicon entries that satisfy the third set of constraints based at least in part on a number of satisfied constraints of the third set of constraints, and categorizing the set of lexicon entries that satisfy the third set of constraints based at least in part on the third set of constraints.

6. A system, comprising:
at least one computing device configured to implement one or more services, wherein the one or more services are configured to:
apply a set of sound pattern constraints to select a first subset of a set of lexicon entries, each sound pattern constraint of the set of sound pattern constraints specifying one or more word positions of a phonetic sound, each lexicon entry in the first subset selected based at least in part on the lexicon entry satisfying a subset of the set of sound pattern constraints;
apply a set of non-sound specific constraints to select a second subset of the set of lexicon entries, each non-sound specific constraint of the set of non-sound specific constraints specifying one or more non-sound specific aspects of a word, each lexicon entry of the second subset selected based at least in part on the lexicon entry satisfying a subset of the set of non-sound specific constraints; and
provide a third subset of the set of lexicon entries, the third subset including lexicon entries contained in the first subset and the second subset.

7. The computing system of claim 6, wherein each sound pattern constraint of the set of sound pattern constraints is specified as a corresponding regular expression constraint, the corresponding regular expression constraint generated from the sound pattern constraint by at least generating a regular expression corresponding to the sound pattern constraint.

8. The computing system of claim 6, wherein the one or more non-sound specific aspects of the word include at least a number of syllables of the word.

9. The computing system of claim 6, wherein the one or more services are further configured to:
select a first sound pattern constraint of the set of sound pattern constraints;
generate a first constraint by combining each sound pattern constraint of a subset of the set of sound pattern constraints with the first sound pattern constraint using a corresponding Boolean operator;
generate a second constraint by combining each non-sound specific constraint of a subset of the set of non-sound specific constraints with the first constraint using a corresponding Boolean operator;
apply the second constraint to select a fourth subset of the set of lexicon entries, each lexicon entry of the fourth subset selected based at least in part on the lexicon entry satisfying the second constraint; and
provide the fourth subset of the set of lexicon entries.

10. The computing system of claim 6, wherein the set of lexicon entries is stored in a lexicon database.

11. The computing system of claim 6, wherein the one or more services are further configured to perform one or more markup operations on the third subset of the set of lexicon entries, the one or more markup operations including at least one of: set font color, set underlined, set boldfaced, set italics, or set font size.

12. The computing system of claim 6, wherein the one or more services are further configured to categorize the third subset of the set of lexicon entries, the categorization based at least in part on the set of sound pattern constraints and the set of non-sound specific constraints.

13. The computing system of claim 6, wherein each lexicon entry of the set of lexicon entries includes at least a word, a language of the word, and a pronunciation of the word, the pronunciation determined based at least in part on the language of the word.

14. A tangible non-transitory computer-readable storage medium having stored thereon executable instructions that, when executed by one or more processors of a computer system, cause the computer system to at least:
present a user interface, the user interface configured to receive inputs and generate a constraint usable to select a subset of a set of lexicon entries, the constraint based at least in part on one or more sound pattern constraints and one or more non-sound specific constraints based at least in part on the received inputs, the one or more sound pattern constraints each specifying one or more word positions of a phonetic sound, the one or more non-sound specific constraints each specifying one or more non-sound specific aspects of a word;
select a subset of the set of lexicon entries based at least in part on the constraint;
process the subset of the set of lexicon entries to produce a processed set of lexicon entries;
provide the processed set of lexicon entries using the user interface; and
update the user interface in accordance with a subset of the set of lexicon entries.

15. The tangible non-transitory computer-readable storage medium of claim 14, wherein the instructions further comprise instructions that, when executed by the one or more processors, cause the computer system to generate the set of lexicon entries based at least in part on a dictionary, the dictionary specifying a set of words in a language.

16. The tangible non-transitory computer-readable storage medium of claim 15, wherein the instructions further comprise instructions that, when executed by the one or more processors, cause the computer system to generate the set of lexicon entries based at least in part on processing one or more audio files to produce the dictionary.

17. The tangible non-transitory computer-readable storage medium of claim 14, wherein:
the set of lexicon entries is stored in a lexicon database; and
the constraint is specified using a database query language, the database query language selected based at least in part on the lexicon database.

18. The tangible non-transitory computer-readable storage medium of claim 14, wherein the instructions that cause the computer system to process the subset of the set of lexicon entries to produce a processed set of lexicon entries further include instructions that, when executed by the one or more processors, cause the computer system to change one or more font attributes associated with the lexicon entries.

19. The tangible non-transitory computer-readable storage medium of claim 14, wherein the instructions that cause the computer system to process the subset of the set of lexicon entries to produce a processed set of lexicon entries further include instructions that, when executed by the one or more processors, cause the computer system to categorize the lexicon entries based at least in part on the constraint.

20. The tangible non-transitory computer-readable storage medium of claim 14, wherein each lexicon entry of the set of lexicon entries includes at least a word, one or more languages associated with the word, and one or more pronunciations of the word, each pronunciation of the one or more pronunciations specified using a phonetic alphabet, each pronunciation determined based at least in part on the one or more languages of the word.
